(19) United States
(12) Patent Application Publication
(10) Pub. No.: US 2019/0135355 A1
(43) Pub. Date: May 9, 2019

(54) APPARATUSES AND METHODS FOR WIRELESS AUTOMATIC OPERATION OF AN AERODYNAMIC DRAG REDUCTION DEVICE

(71) Applicant: Stemco Products, Inc., Charlotte, NC (US)

(72) Inventors: Mark Kranz, Longview, TX (US); Daniel Harding, Longview, TX (US); Court Hinricher, Longview, TX (US); Austin Duncanson, Longview, TX (US); Michael Polidori, Longview, TX (US)

(21) Appl. No.: 16/312,475

(22) PCT Filed: Jun. 28, 2017
(86) PCT No.: PCT/US17/39680

§ 371 Date: Dec. 21, 2018

Related U.S. Application Data
(60) Provisional application No. 62/356,263, filed on Jun. 29, 2016.

(51) Int. Cl. B62D 35/00; B62D 37/02; B60W 30/02; B60W 40/105

(52) U.S. Cl. CPC B62D 35/001; B62D 37/02; B60W 30/02; B60W 2530/12; B60W 2300/14; B60W 2520/28; B60W 40/105

(57) ABSTRACT

A latch for an aerodynamic structure is provided. The latch includes a transceiver and antenna coupled to a processor that receives signals indicative of speed. The processor causes the latch driver to be energized to release the latch to deploy the aerodynamic structure.

### CROSS-REFERENCE TO RELATED PATENT APPLICATIONS

This application is a § 371 U.S. National Application of International Application No. PCT/US2017/039680 filed Jun. 28, 2017, which claims priority to U.S. Provisional Patent Application Ser. No. 62/356,263, filed Jun. 29, 2016, the entirety of each of which is incorporated herein by reference for all purposes and relied upon.

### BACKGROUND

Trucking is the primary mode of long-distance and short-haul transport for goods and materials in the United States, and many other countries. Trucks typically include a motorized cab in which the driver sits and operates the vehicle. The cab is attached to a box-like cargo body. Smaller trucks typically include an integral cargo body that sits on a unified frame that extends from the front wheels to the rear wheel assembly. Larger trucks often include a detachable cab unit, with multiple driven axles, and a separate trailer with a long box-like cargo unit seated atop two or more sets of wheel assemblies. These truck assemblages are commonly referred to as “semi-trailers” or “tractor trailers.” Most modern trucks' cabs, particularly those of tractor trailers, have been fitted with aerodynamic fairings on their roof, sides, and front. These fairings assist in directing air over the exposed top of the box-like cargo body, which typically extends higher (by several feet) than the average cab roof. The flat, projecting front face of a cargo body is a substantial source of drag, above the cab roof. The use of such front-mounted aerodynamic fairings in recent years has served to significantly lower drag and, therefore, raise fuel economy for trucks, especially those traveling at high speed on open highways.

However, the rear end of the truck's cargo body has remained the same throughout its history. This is mainly because most trucks include large swinging or rolling doors on their rear face. Trucks may also include a lift gate or a lip that is suited particularly to backing the truck into a loading dock area so that goods can be unloaded from the cargo body. It is well-known that the provision of appropriate aerodynamic fairings (typically consisting of an inwardly tapered set of walls) would further reduce the aerodynamic profile of the truck by reducing drag at the rear face. The reduction of drag, in turn, increases fuel economy.

Nevertheless, most attempts to provide aerodynamic structures that integrate with the structure and function of the rear cargo doors of a truck have been unsuccessful and/or impractical to use and operate. Such rear aerodynamic structures are typically large and difficult to remove from the rear so as to access the cargo doors when needed. One approach is to provide a structure that swings upwardly, completely out of the path of the doors. However, aerodynamic structures that swing upwardly require substantial strength or force to be moved away from the doors, and also require substantial height clearance above an already tall cargo body. Other solutions have attempted to provide an aerodynamic structure that hinges to one side of the cargo body. While this requires less force to move, it also requires substantial side clearance—which is generally absent from a closely packed, multi-truck loading dock.

In fact, most loading dock arrangements require that the relatively thin cargo doors of conventional trucks swing open fully to about 270 degrees so that they can be latched against the adjacent sides of the cargo body. Only in this manner can the truck be backed into a standard-side-clearance loading dock, which is often populated by a line of closely-spaced trailers that are frequently entering and leaving the dock. In such an environment, side-projecting or top-projecting fairings would invariably interfere with operations at the loading dock.

A possible solution is to bifurcate the aerodynamic structure into a left hinged and a right-hinged unit that defines a complete unit when closed, and hinges open to reveal the doors. However, the two separate sections still present a large projection that would be incapable of swinging the requisite 270 degrees, and would undesirably tend to project into the adjacent loading bays when opened.

Another alternative is to remove the fairing structure from the truck before it is parked at the loading bay. However, the removed structure must then be placed somewhere during the loading/unloading process. Because most truck doors are relatively large, being in the range of approximately 7-8 feet by 8-9 feet overall, removing, manipulating and storing a fairing in this manner may be impractical, or impossible, for the driver and loading dock staff.

In the face of ever-increasing fuel costs, it is critical to develop aerodynamic structures that can be applied to the rear of a truck cargo body, either as an original fitment, or by retrofit to existing vehicles. These structures should exhibit durability and long service life, be easy to use by the average operator, not interfere with normal loading and unloading operations through a rear cargo door, and not add substantial additional cost or weight to the vehicle. The structure should exhibit a low profile on the vehicle frame and/or doors, not impede side clearance when the doors are opened, and where possible, allow for clearance with respect to conventional door latching mechanisms. Such structures should also allow for lighting on the rear, as well as other legally required structures. Furthermore, it is particularly desirable for control of the position of the aerodynamic structure to be automatic, so that user manipulation is not required and so that the aerodynamic structure is assured of deployment when the vehicle is in motion and at highway speed.

Recently, TRAILERTAIL® aerodynamic devices for cargo bodies have become available from STEMCO LP, 300 Industrial Blvd., Longview, Tex. The TRAILERTAIL® devices generally have at least a top panel and a side panel that extend from the rear of a vertical cargo body about a door. The door, top panel, and side panel are cooperatively coupled such that the TRAILERTAIL® devices may deploy and retract. These devices are further explained in co-owned U.S. Pat. Nos. 8,100,461; 8,272,680; 8,360,509; 8,360,510; 9,145,177; 9,440,688 and co-owned U.S. Published patent application Ser. No. 15/227,206, all of which are incorporated herein as if set out in full. These, and some other similar devices, operate to retract and deploy such that the rear doors of the trucks operate in a conventional manner.

The aerodynamic devices operate by having one of a top panel and a side panel flush with the rear door of a cargo body in the retracted position. The other of the top panel and side panel over lays the panel flush with the door and is generally latched to hold the aerodynamic device in a retracted position. The panels are biased such that releasing the latch causes the panels to move from the retracted position to the deployed position.

The latch holding the panels in a closed position may be a manually operated latch or, in some cases, an automatically operated latch. The automatically operated latch is preferable for configurations of the aerodynamic device that deploy only after a predetermined minimum speed is reached. However, present automatic latches are cumbersome and expensive. Thus, against this background, improved apparatuses and method for automatic latch operation is desirable.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some aspects of the technology, a wireless magnetic or electrical motor powered latch system (generically latch system) is provided. The latch system includes a power source, an antenna, a receiver and a transmitter (sometimes combined as a transceiver), a processor, an energy storage unit (which may be a high voltage capacitor, a capacitor, a battery, or a low voltage battery), and a latch (which may be a mechanical interlock or magnetic interlock). The latch system receives, at the receiver, a signal indicative of the speed of the vehicle (or cargo body). If the speed of the vehicle exceeds a predetermined threshold, the processor would provide a control signal to open the latch to allow the aerodynamic device to deploy. In certain aspects, the latch system would receive a signal indicative of or corresponding to a speed of the vehicle, which speed may be calculated by revolutions of a wheel on the cargo body. In other aspects, the latch system may be operated by a vehicle operator of the vehicle. In this other embodiments, the latch system may be operated by other systems incorporated into the vehicle, such as, for example, electronic control units (ECUs), antilock brake systems (ABS), or the like.

In other aspects, a driver, such as a latch driver, may be used to power actuators, such as, for example, pneumatic actuators, motor actuators, electro-magnetic actuators, or the like. The driver may receive a vehicle speed signal (or an alternative signal as outlined herein) and, based on the speed signal, cause the actuator to actuate and open or close the aerodynamic drag reducing device, such as a boat tail device. In certain aspects, the vehicle operator may elect to deploy the device regardless of receiving a deployment signal.

The latch may be powered by an electromagnetic switch or a motor operated latch. The operation (from closed to open or open to closed) may be energized by a high voltage capacitor (sometimes referred to as a high voltage super capacitor), as identified herein, or a battery in certain aspects. The capacitor may include a leakage current after operation. The leakage current may be used to power components of the latch system to prolong the power source, which is typically a battery. Thus, a voltage regulator would monitor the leakage current and, when the leakage current is insufficient to power the components of the latch system, the processor may open a switch to cause the power source to power the latch system components and/or supplement the latch system components.

In certain aspects, the speed signal identified above may be provided by a radar speed detection system. In other aspects, the speed signal identified above may be provided by a hub odometer providing a signal representative of rotations of a wheel per a time interval, which is convertible to a speed signal. In yet other aspects, the speed signal identified above may be provide by a global positioning system.

These and other aspects of the present system and method will be apparent after consideration of the Detailed Description and Figures herein.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 is a perspective view of a latch consistent with the technology of the present application.

FIG. 2 is a view of a latch driver capable of driving the latch of FIG. 1 consistent with the technology of the present application.

FIG. 3 is a functional block diagram of the latch driver of FIG. 2.

FIG. 4 is a view of a wheel with an accelerometer to determine wheel revolutions consistent with the technology of the present application.

FIG. 5 shows a plot of x-axis and y-axis acceleration data generated by an accelerometer mounted in the center of a wheel in an embodiment of the present invention.

FIG. 6 shows a plot of x-axis and y-axis acceleration data generated by an accelerometer mounted at a distance R from the wheel center in an embodiment of the present invention.

FIG. 7 is a perspective view of a cargo body with an indicator consistent with the technology of the present application.

FIG. 8 is a view of an aerodynamic device in a retracted position consistent with the technology of the present application.

FIG. 9 is a view of an aerodynamic device in a partially retracted position consistent with the technology of the present application.

FIG. 10 is a view of an aerodynamic device in the deployed position consistent with the technology of the present application.

FIG. 11 is a functional block diagram of a control system consistent with the technology of the present application.

### DETAILED DESCRIPTION

The technology of the present application will now be described more fully below with reference to the accompanying figures, which form a part hereof and show, by way of illustration, specific exemplary embodiments. These embodiments are disclosed in sufficient detail to enable those skilled in the art to practice the technology of the present application. However, embodiments may be implemented in many different forms and should not be construed as being limited to the embodiments set forth herein. The following detailed description is, therefore, not to be taken in a limiting sense.

The technology of the present application is described with specific reference to aerodynamic devices having a retracted position, where panels are latched in the retracted position, and a deployed position, where the panels are unlatched and deployed. However, the technology described herein may be used for other operations where a wireless or remote latch system is used.

The technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

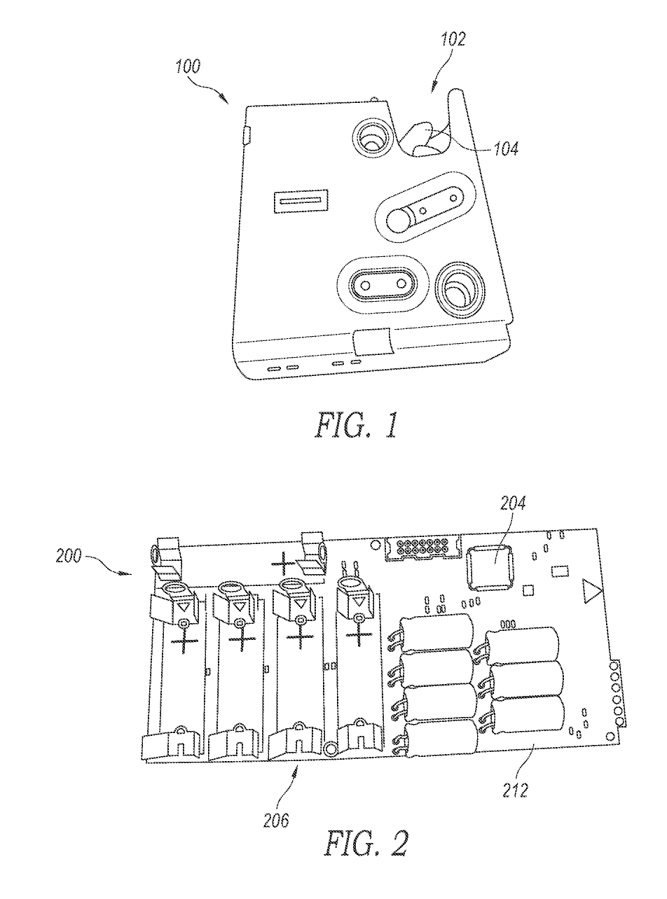

With reference now to FIG. 1, an electro-motorized latch (generically latch) 100 is shown that is consistent with the technology of the present application. The latch 100 includes a slot 102 into which a member coupled to a panel may enter and exit. In the closed state, a cam 104, or lock arm, would extend into the slot 102 to retain the member. The motor (not shown, but internal to the latch 100) would hold the cam 104 in place, forming a mechanical and releasable interlock. A signal to the electro-motorized latch 100 causes the motor to move the cam 104 out of the slot 102 into an open state. Once the cam 104 is removed, the member would be moved by biasing members on the attached panel causing the member to exit the slot 102. Alternatively, an actuator may cause the panels to move as explained further below. One exemplary latch comprises a R4-EM latch available from Southco, Inc., which has offices at 210 North Brinton Lake Road, Concordville, Pa. The aerodynamic devices coupled to the rear of a cargo body typically comprise a driver side portion and a curb side portion. Thus, each cargo body would typically have two (2) electro-motorized latches 100. Also, while described as an electro-motorized latch 100, the latch 100 could instead be a magnetic latch, a spring based latch, a combination thereof, or the like. In other words, in certain embodiments, the cam 104 may be held in place by magnets or springs rather than a motor such that the release signal would de-energize the magnet or release a spring, allowing the cam 104 to open.

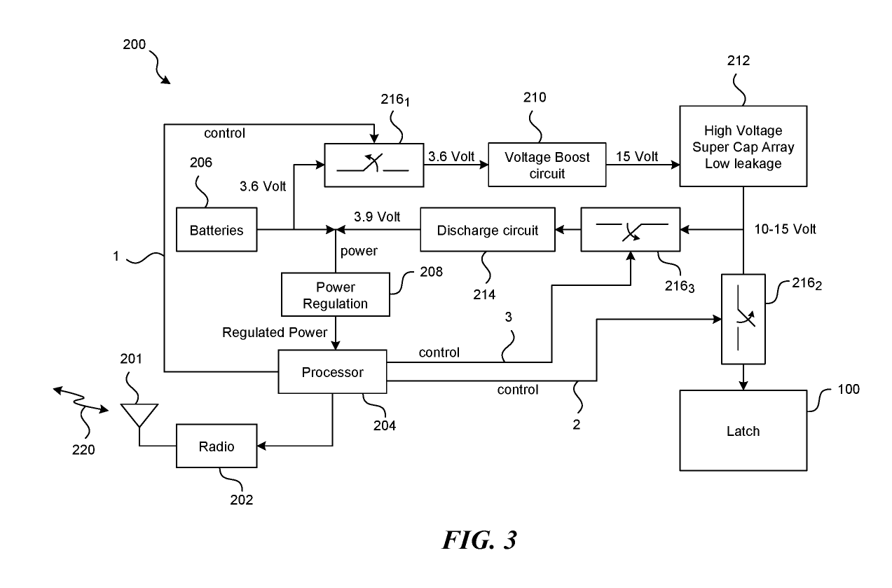

FIG. 2 shows a latch driver 200 capable of driving the motor associated with the electro-motorized latch 100. The latch driver 200 is designated as a latch driver as it is used to operate the electro-motorized latch 100. The latch driver 200 may drive other components, however. For example, the latch driver 200 may drive a pneumatic actuator, a motorized actuator, an electro-magnetic actuator, or the like. As such, the latch driver 200 may be designated as an actuator driver in certain aspects of the technology. One latch driver 200 is typically associated with each electro-motorized latch 100, although only one is explained herein. The latch driver 200 is shown as a functional block diagram in FIG. 3. The latch driver 200 includes a transceiver 202 (or radio) including an antenna 201, a processor 204, a power source 206, a power regulation module 208, a voltage boost circuit 210, a high voltage super capacitor array 212, a discharge circuit 214, and a plurality of switches 216, which include switch 216₁, switch 216₂, and switch 216₃ as shown. High voltage, in this particular disclosure, relates to voltages greater than about 4 volts. One (1) latch driver 200 may be used for each of the two (2) latches 100 associated with the cargo body. In certain embodiments, the latch drivers 200 may share certain parts/components. For example, the antenna 201, transceiver 202, and the processor 204 may be provided on one of the latch drivers 200, such as for example, the driver side latch driver 200_{d}. The output control signals of the processor 204, which will be explained further below, may be routed to the associated driver side latch driver 200_{d} and the curb side latch driver 200_{c} reducing the overall number or pieces and parts, but requiring additional wiring or wireless technology.

During operation, the antenna 201 and transceiver 202 would receive a signal 220 and transmit the signal to the processor 204. The signal, which will be explained further below, may be indicative of a speed of the cargo body. The signal 220 would be used by the processor 204 to determine whether the speed of the cargo body (or other vehicle) is greater than a predetermined speed. The processor 204 may receive the signal 220 and further process the signal into a value indicative of the actual speed of the vehicle, in for example, miles/hour, or the like. The actual speed of the vehicle would be compared to a pre-set speed value, such as, 35 miles/hour. If the signal 220 corresponds to or exceeds the pre-set speed value, the processor issues a series of control signals, such as control signal 1, control signal 2, and control signal 3 in this exemplary embodiment. The pre-set speed value, while listed as 35 miles/hour in this exemplary embodiment, may be any pre-set speed value as a matter of design choice and operational characteristics of the device. It has been found, however, that deploying an aerodynamic device on the tail of a vehicle, such as, a cargo body, at approximately 35 miles/hour is efficient. In one embodiment, the pre-set speed value may be selectable using an user interface or input device associated with the processor 204 to allow the fleet manager or the vehicle operator to set the pre-set speed. In certain embodiments, the processor 204 may be configured with two (2), three (3), or more pre-set speed values that are individually selectable.

When processor 204 determines the vehicle speed is such that the latch 100 should be opened (or released) to deploy the aerodynamic device, the processor 204 may initialize the latch driver 200 by using control signals 2 and 3 to open switches 216₂ and 216₃. The processor 204 transmits control signal 1 to switch 216₁ causing the switch to close placing the power source 206 in electrical communication with the voltage boost circuit 210. The voltage boost circuit 210 steps up the voltage from the power source 206 from a first voltage to a second voltage, where the second voltage is sufficient to charge the high voltage super capacitor array 212. The second voltage is greater than the first voltage. It is envisioned that the power source 206 would comprise one or more batteries outputting the first voltage, which would be below the voltage requirements of the high voltage super capacitor array 212. Thus, the voltage boost circuit 210 will be used to boost the voltage from the first voltage, which may be 3.6 volts in some embodiments, to the second voltage, which may be 15 volts in some embodiments. The voltage boost circuit 210 may be any number of conventional voltage boost circuits, which typically boost voltage by limit amperage. If the power source 206 provides a sufficiently high voltage in the first instance, the voltage boost circuit 210 may be removed from the latch driver 200 as it is not necessary.

The voltage boost circuit 210 charges the high voltage super capacitor array 212 until a sufficient charge is contained on the high voltage super capacitor array 212 to drive the latch 100. A voltage sensor (not specifically shown) may be used by the processor 204 to determine when the voltage stored on the high voltage super capacitor array 212 is sufficient. Alternatively, a timer may be used. Other means of determining the voltage stored on the high voltage super capacitor array 212 may be used other than the two mentioned herein.

Once the high voltage super capacitor array 212 has a sufficient charge, the processor 204 may use control signal 1 to open switch 216₁ to stop charging the high voltage super capacitor array 212. At substantially the same time or after a slight time lag, the processor 204 may use control signal 2 to close switch 216₂ placing the high voltage super capacitor array 212 in electrical communication with the latch 100. The latch 100, whether an electric motor driven latch, a magnetic latch, another type of powered latch, or a combination thereof, uses the voltage stored on the high voltage super capacitor array 212 to open (or release) the latch 100, which allows the aerodynamic device, in this exemplary embodiment, to deploy. As can be appreciated, the power source 206 may, in certain instances, be used to directly drive the latch 100. However, it is envisioned that the requirements of a latch sufficient to maintain a mechanical or magnetic lock on the aerodynamic device would drain any currently available conventional batteries to be used for the power source quickly requiring a significant amount of maintenance for the power source. Maintenance requires the cargo body to be out of operation, which causes a loss of revenue associated with the cargo body. In some embodiments, high capacity batteries may be used for the power source, but sufficiently higher source batteries may be expensive and/or heavy, which also reduces overall revenues.

Once the latch 100 is released, the processor 204 uses control signal 2 to open switch 216₂. The processor 204 may determine the latch 100 is released by receiving a signal from the latch 100, from the voltage sensor mentioned above, indicating that the discharge from the high voltage super capacitor array 212 is sufficient to open the latch 100, or from a current sensor indicating that the latch 100 is no longer drawing current sufficient to drive the latch 100. In any event, the high voltage super capacitor 212 still contains a charge higher than the typical battery voltage, although below the second voltage. The high voltage super capacitor 212 will have a trickle or low leakage discharge at a third voltage less than the second voltage but greater than the first voltage. It may be possible to scavenge the residual voltage stored in the high voltage super capacitor 212. To accomplish this, the processor 204 may send control signal 3 to switch 216₃ subsequent (or at the same time) to as sending control signal 2 to open switch 216₂. Control signal 3 would close switch 216₃, placing the high voltage super capacitor array 212 into electrical communication with the discharge circuit 214.

The discharge circuit 214 reduces the voltage from the output of the high voltage super capacitor array from the third voltage to a fourth voltage, which is less than the third voltage. The voltage reduction circuit may be any conventional reduction circuit. The fourth voltage may be equal to the first voltage, which is the voltage output of the power source 206. Alternatively, the fourth voltage may be slightly greater than the third voltage. The fourth voltage would be input to the power regulator 208 to power the processor 204, transceiver 202 (or radio 202), and antenna 201. The discharge circuit 214 output and the power source 206 output are arranged in parallel to the power regulator 208 such that when the fourth voltage falls below the threshold and the processor 204 opens switch 216₃, the voltage to power regulator 208 automatically switches to the power source 206, or batteries, and does not induce a low voltage condition for the downstream components. The processor 204 would monitor the fourth voltage and, when the fourth voltage dips below a threshold, the processor uses control signal 3 to open switch 216₃ such that the power regulator is disconnected from the discharge circuit and the power source provides the power to the power regulator. In certain embodiments, the power source 206 comprises rechargeable batteries that may be charged using the leakage from the high voltage super capacitor array 212 to scavenge some of the energy.

The antenna 201 and transceiver 202 are capable of receiving signals indicative of the speed of the vehicle. One device capable of determining speed includes a wheel speed sensor typically associated with an anti-lock braking system. Another device uses radar to determine speed. The radar signal may be transmitted to the antenna and communicated through the transceiver 202 to the processor 204. The processor 204 may use the radar based speed signal to determine whether the vehicle/cargo body has increased its speed above a predetermined threshold speed (see above). Radar, however, has certain limitations including, for example, difficulties operating in adverse conditions such as snow, rain, dirt, or the like.

Many safety standards require vehicle fleets to monitor wheel revolutions. In certain aspects of the technology disclosed herein, the wheel revolutions may be used to determine the vehicle speed. Devices to determine wheel revolutions include HUBODOMETER® odometers available from STEMCO LP of Longview, Tex. Such HUBODOMETER® odometer is further described in U.S. Pat. Nos. 6,940,940 and 8,352,210, the disclosures of which are incorporated herein by reference as if set out in full. One exemplary electrical hub odometer is explained below for completeness, but mechanical, electrical, or mechanical-electrical hub odometers are available to reliably monitor wheel revolutions. Using the wheel-revolutions, the circumference of the wheel, and time, the speed of the vehicle is determinable as explained below.

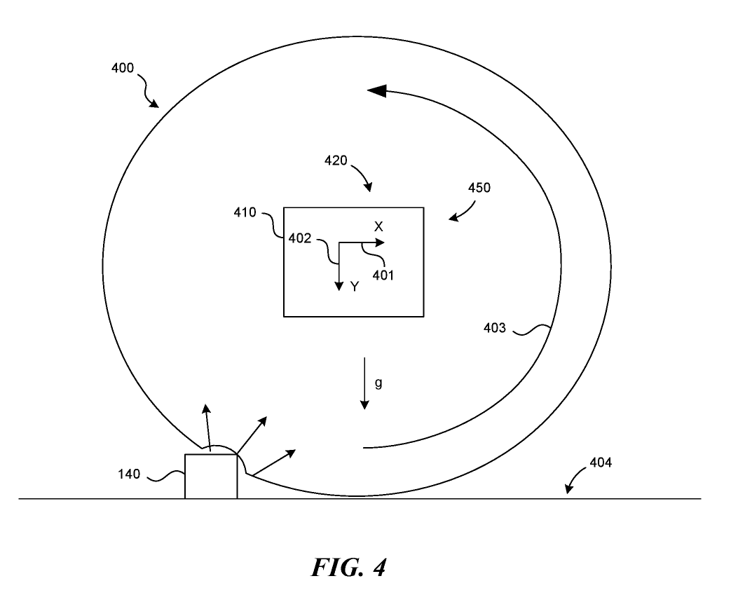

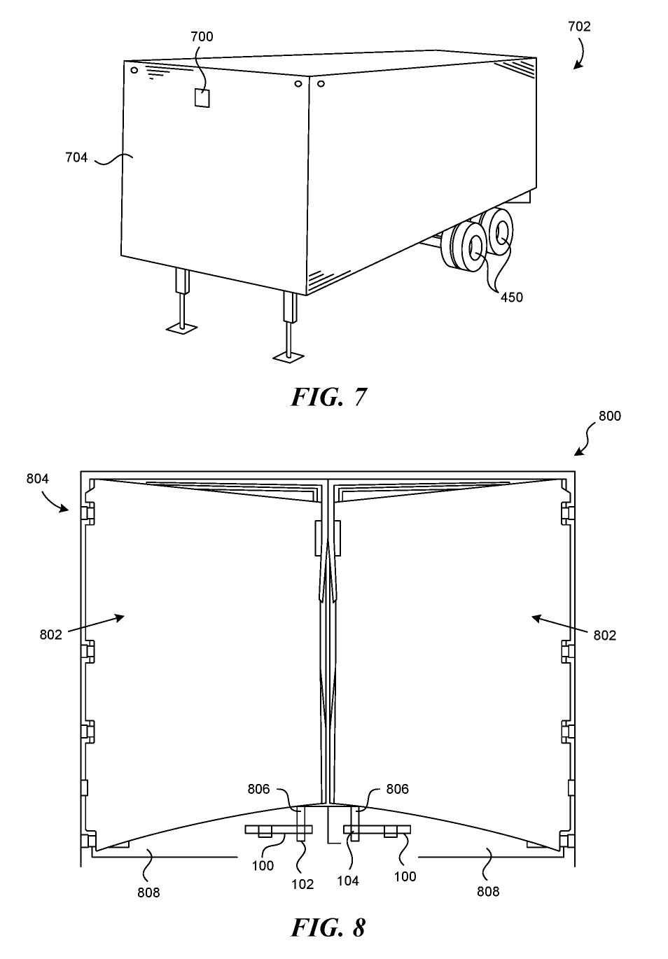

For completeness, an exemplary device to determine wheel revolutions is described. FIG. 4 represents a wheel 400 of the cargo body. The wheel 400 includes a hub odometer 450 (see FIG. 7 also). The hub odometer 450 may include a processor and transceiver to transmit signals to the latch driver described above. The signal transmitted to the latch driver may be revolutions of the wheel, revolutions per unit of time (such as RPM), mileage, and/or mileage per unit of time (such as MPH). A dual axis accelerometer 410 is mounted at the center 420 of the wheel 400, proximal to the axle on which the wheel 400 rotates. The dual axis accelerometer 410 detects force along two (dual) axes, which are classified as an x-axis 401 and a y-axis 402 in this exemplary embodiment. As the wheel 400 rotates in a counter clockwise direction, as shown by the arrow 403, the orientation of the axis will change with respect to the surface 404, which is typically a road surface or ground.

Assuming a flat surface, the force of gravity (g) is felt in a direction perpendicular to the ground 404. Before the wheel starts to turn, the y-axis 402 of the accelerometer will detect the full force of gravity (1 g), and the x-axis 401 will not detect any force from gravity because the force is acting on the x-axis sensor perpendicular to the direction of detection (i.e. the force has no x-axis component). As the rotation begins in the direction indicated by the arrow 403, the accelerometer will detect decreasing values along the y-axis as the y-axis approaches an orientation perpendicular to the force of gravity. Simultaneously, the x-axis will detect an increasing force of gravity in a negative direction as it approaches an orientation parallel, but opposite to, the gravitational pull. After one-quarter turn of the wheel, the x-axis is oriented directly upward and detects 1 g of force. The y-axis would be perpendicular to the direction of gravity and would detect no force.

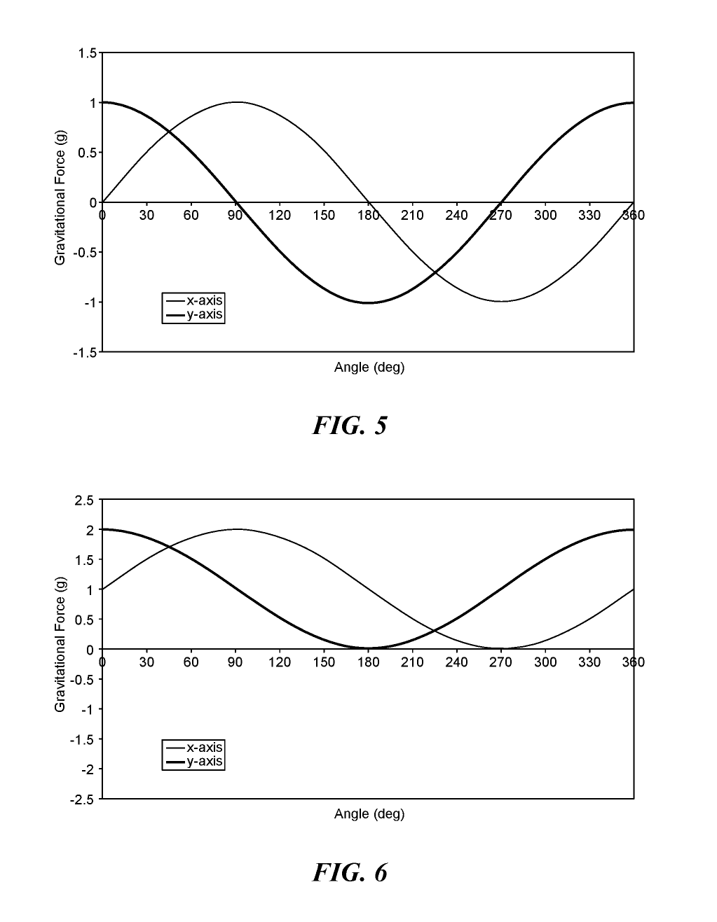

As the wheel continues to rotate, the resulting force felt by the x-axis and y-axis will continue to cycle through a range from +1 to −1 in a sinusoidal fashion, offset by 90°. The result, as illustrated in FIG. 5, are two sinusoidal curves, the x-axis producing a sine curve, and the y-axis producing a cosine curve. One complete period of the curve, or 360°, corresponds to one complete revolution of the wheel 400. Similarly, a partial period of the curve corresponds to a partial rotation of the wheel.

If the accelerometer 410 is not located at the center 420 of the wheel, the force felt by the x-axis and y-axis sensors will ride on a centripetal acceleration reading that will vary with radial distance from the center of the wheel. For example, at a given distance “R” from the center of the wheel, the accelerometer will detect a constant force “F” due to the centripetal force of the spinning wheel. This force “F” will also vary with the angular velocity of the wheel. As such, F is only constant for a given velocity.

In addition to the velocity dependent centripetal force, the sensors will detect the cyclical gravitational force of +/−1 g, as discussed above. Therefore, in an embodiment of the present invention wherein the accelerometer is mounted away from the center of the wheel, the same sinusoidal pattern will be reported by the accelerometer, only it will have “shifted” due to the centripetal acceleration experienced by the sensors. This is illustrated in the acceleration plot in FIG. 6 in which the centripetal acceleration produces a constant 1 g of force, and the force due to gravity cycles through the +/−1 sinusoidal pattern. This is assuming a constant angular velocity throughout the plot.

The output of the accelerometer x-axis and y-axis sensors is a DC voltage that varies with measured force. Thus, a full rotation of the wheel is represented by a sine or cosine wave of DC voltage as output from the accelerometer. The odometer count of wheel revolutions is equivalent to the number of periods of the curve.

In a further embodiment of the present invention, once the acceleration signal is generated by the accelerometer, it is communicated to a printed circuit board, or other such device, to be converted to a suitable format through the electronic components of the odometer. The signal corning from the accelerometer is a DC voltage that is proportional to the force exerted on the accelerometer. As discussed previously, this is a sinusoidal wave; however, impacts and other disturbances will cause spikes and other anomalies in the curve. These irregularities in the curve will add inaccuracies to the odometer data if not corrected. Electronic data manipulation is performed to interpret this signal from the accelerometer, correct for spikes and abnormalities in order to increase the accuracy of the data. Once the accelerometer data is “clean”, the microcontroller can calculate other useful data such as velocity, acceleration of the wheel, and rotation counts.

Mileage is equivalent to the wheel revolution count multiplied by the circumference of the wheel. The mileage may be converted to mileage per unit of time, which is convertible to the speed component as outlined above. The processor 204, above, uses the signal from the revolution determining device to compare the actual speed of the cargo body to determine whether the latch should be released, opened, to deploy the aerodynamic device.

While the above describes an electronic hub odometer, a mechanical hub odometer may be used in the alternative. The mechanical hub odometer provides a mechanical, typically geared, connection to the axle such that the revolutions of the tire correspond to revolutions of the drive shaft. Thus, the mechanical hub odometer uses a mechanical connection to the axle to count revolutions rather than the movement of associated accelerometers. The mechanical hub odometer can be coupled to a processor that converts the mechanical count to a signal corresponding to the count, which signal can be converted to mileage or speed as explained above and transmitted to the processor 204.

Once the aerodynamic device is deployed, the processor 204 causes the radio to transmit a deployed signal to an indicator 700, which could be a visual indicator, an audio indicator, or a combination thereof as shown in FIG. 7. FIG. 7 shows a cargo body 702 having an indicator 700 located on the forward outer panel 704 of the cargo body 702. While shown somewhat centered and high on the panel, the indicator 700 would be placed at a position to allow the operator (or driver) to easily see the indicator. The indicator 700 is placed where the driver or operator of the vehicle will see and/or hear that the aerodynamic device is deployed. In certain embodiments, the indicator 700 may be placed on the cargo body in a position where the indicator 700 is visible in a mirror, such as a rearview mirror. In other embodiments, the indicator 700 may be placed within the cab to which the cargo body is attached. One particularly useful indicator 700 is described in U.S. Pat. No. 9,090,206, titled “On-board low-power vehicle condition indicator”, a copy of which is incorporated herein by reference as if set out in full. On receiving a signal from the processor 204, through the transceiver 202 and antenna 201, the indicator 700 may transition from a first state to a second state. In the first state, the indicator 700 has a first visual indicator that indicates the aerodynamic device is retracted because the latch system has not been released, which would cause auto-deployment of the aerodynamic device. When the latch driver releases the latch 100, the signal is transmitted to the indicator 700 that causes the indicator 700 to move to a second state and provide a second visual indicator. The second state is maintained by the indicator 700 even if power is removed from the indicator such that the operator can register that the indicator 700 indicates the aerodynamic device is in the deployed condition. The first visual indicator may be, for example, a black color and the second visual indicator may be, for example, a neon orange color. The second indicator color would be chosen such that the color has a high visibility recognition. The indicator 700 should alert the operator that the device is deployed in the event the operator is in reverse.

As can be appreciated, the latch driver 200, the hub odometer 450, and the indicator 700 may be wireless devices although in certain embodiments the devices may be coupled by wires, such as, for example, twisted pair, coaxial, ribbon cable, or the like. As the devices are typically all associated with a single cargo body, it may be possible to bind the devices using traditional wireless handshaking protocols. Such handshaking may be considered hard binding the transmitters and receivers to each other. In other embodiments, the latch driver 200, the hub odometer 450, and the indicator 700 may need be bound only after the cargo body travels above a pre-set speed for a pre-set period of time. The processors would sense the wireless presence of various transmitters and, if those transmitters are continuously sensed for a period of time that the cargo-body is traveling over a pre-set speed, the sensors and processors would be wirelessly bound. Such awareness or other binding techniques may be considered soft binding the transmitters and receivers to each other.

Once the transmitters and receivers are bound, they begin tracking each other. The receiver (such as the indicator 700) tags the time that the sensor (such as the latch driver 200) was last read on and predicts a future time that the sensor (or the latch driver 200 in this case) will be transmitting again. When the sensor is read again, a time delta is calculated to figure out the minimum time between transmit intervals. When this model is refined, the indicator 700 may reduce the listen time so that the radio system only listens when a sensor is going to transmit. Such use of the radio system reduces power consumption of the visual indicator. In one embodiment, after a few sensor transmit intervals, the visual indicator builds a drift model to further tighten the listen time by calculating how fast the transmit interval is moving with temperature or aging. This is referred to as an adaptive listening envelope. If a sensor is blocked for a period of time, the visual indicator notes that the sensor model needs a full update and will schedule a reacquire interval where the radio system will remain active for a longer period of time in order to reacquire the signals from the bound sensors.

For completeness, FIG. 8 shows an aerodynamic device 800 in the closed position. The aerodynamic device 800 may include a pair of side panels 802 foldable over rear doors 808 of a cargo body 804. Each of the side panels 802 include a member 806 that operatively engages the latch 100 by fitting into the slot 102 and being held by the lever 104. In one embodiment, the member 806 may be a pin projecting vertically and downwardly along the interior surface of the side panel 802. The member 806 projects slightly below the bottom edge of the side panel 802 in this exemplary embodiment. The latch 100 is provided on the rear door 808 of the cargo body to operatively engage the member 806. The aerodynamic device 800 may include one or more top panels, side panels, and lower panels that are operatively coupled to fold and unfold in a coordinated movement. One or more of the panels and/or rear doors may be operatively coupled to link members to facilitate the coordinated movement by transmitting operating forces.

The aerodynamic device 800 shows an exemplary arrangement of panels that is illustrative of a wide range of deployable aerodynamic structures. The latch 100 is generally described as being driven by a hub odometer and converting the revolutions to a speed signal, a speed sensor as described herein, or the like, but can be actuated by other existing on-board systems found on most modern trucks such as, for example, the electronic control unit (ECU), antilock braking system (ABS), and various components of the pneumatic pressure system, including pumps, pressure storage tanks, and control valves such as are described in for example, co-owned U.S. Pat. No. 9,145,177, the disclosure of which is incorporated by reference as if set out in full for all possible purposes.

The latch driver 200, as described above, discharges to open the cam 104 to allow a biasing system or actuator to drive the aerodynamic device 800 to a deployed position. The latch driver 200 may power the actuator in certain embodiments. International Application publication number WO16/154224, titled Rear Aerodynamic Structure for Cargo Bodies and Actuation Mechanisms for the same, and U.S. patent application Ser. No. 14/830,114, titled Retractable Aerodynamic Structures for Cargo Bodies and Methods of Controlling the Positioning of the same, both of which are co-owned and incorporated by reference herein as if set out in full, disclose certain embodiments where the latch driver 200 could be incorporated to drive the actuators and/or valves in conjunction with the latch 100.

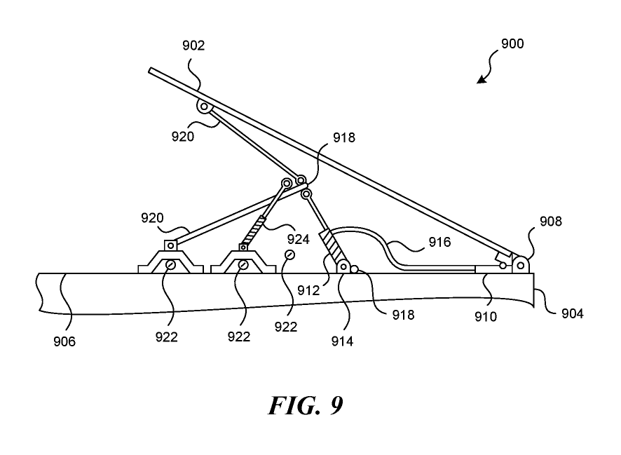

FIG. 9 shows a top view of an exemplary aerodynamic structure 900 consistent with the above. The aerodynamic structure 900 includes at least one panel 902, device hinge 910, active actuator 912, passive actuator 924, and linkage 920, which may be a single member or multiple members. Panel 902 has both a deployed position in which panel 902 is positioned away from the door 906 of the cargo body (e.g., the position depicted in FIG. 9 shows the door 906 partially deployed) and a retracted position in which the panel 902 is positioned closer to or against the door 906, with a gap or space sufficient to enclose the hardware described above. As used herein, active generally means some sort of motivating force is required, such as an electrical motor actuator, a magnetic actuator, or a fluid (pneumatic or hydraulic) actuator. As used herein, passive generally means a device that is biased in a particular direction such as a spring, a gas-spring, tension devices, or compression devices. The actuator 912, in certain embodiments, may be passive, and the actuator 924, in certain embodiments, may be active. Also, both actuators 912 and 924 may be active or, in the alternative, a single actuator 912 for example, may be operable in a forward and reverse direction such that only a single actuator is necessary.

The panel 902, in this exemplary embodiment, may be biased into the deployed position using the passive actuator 924, such as a gas-spring for example. The passive actuator 924 is coupled to the cargo body (or the doors) using a joint, such as, for example, a ball joint, a gimbal, or a hinge. The passive actuator 924 is coupled to the linkage 920 at the other end using a similar joint. The linkage 920 is coupled to the panel 902 (or panels) to push the panel 902 into a deployed position. Other panels, such as a top or bottom panel, would be interconnected with either the linkage 920 or the panel 902 such that movement of linkage 920 and/or panel 902 between the deployed and retracted position causes the interconnected panel to move concurrently.

The panel 902 also can be moved from the deployed position to the retracted (or partially retracted) position by active actuator 912. The active actuator 912 pulls the panel 902 against the force of the passive actuator 924. As shown, the active actuator 912 is coupled to the door 906 at a first end and to the linkage 920 at a second end using joints similar to the above. The interconnection between other panels causes concurrent movement as described above.

The active actuator 912, in this exemplary embodiment, may be a pneumatic actuator. The motive force, air, may be provided to active actuator 912 by an airline 916. As the actuator 912 retracts, air in actuator 912 on the opposite side of the piston is vented or provided to reservoir 914. The air pressure provided to actuator 912 pulls the rod and draws the panel 902 and/or linkage 920 towards the door overcoming the bias of passive actuator 924. Once retracted, the latch 100 described above would engage and hold the panel 902 (or panels) in the retracted position.

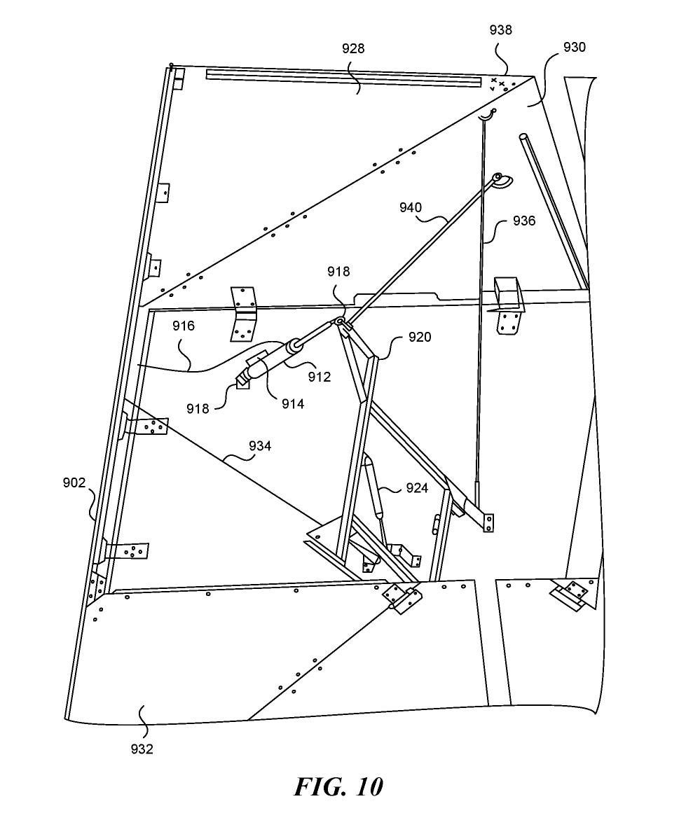

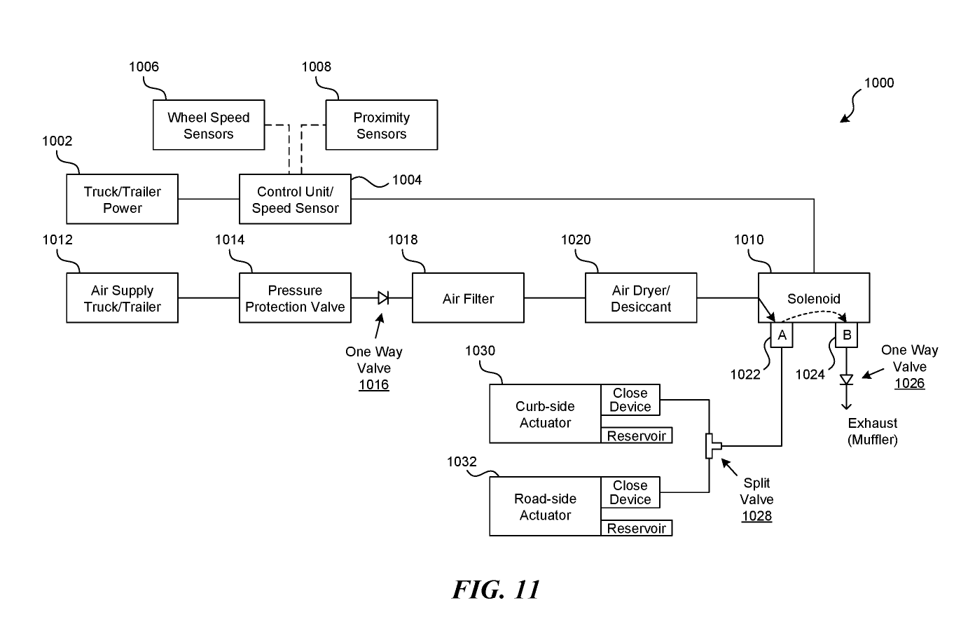

FIG. 10 shows another view of an aerodynamic structure 900. As can be appreciated, FIGS. 9 and 10 only show the aerodynamic structure 900 on a single side for clarity. The aerodynamic structure 900 has bottom panel 932, side panel 902, top panel 938, active actuator 912, passive actuator 924, airline 916, and linkage 920. The panels are shown deployed.

The linkage 920 is coupled to passive actuator 924 and active actuator 912 as well as bottom panel 932, top panel 938, and side panel 902. Similar to as described above, the arrangement is such that the aerodynamic structure 900 retracts and deploys the panels concurrently. In this exemplary embodiment, the linkage 920 is coupled to an inner ½ 930 of the top panel 738 using a rod 940 and cable 936. The linkage 920 also may be coupled to the side panel 902 by a cable 92. Finally, although not completely depicted in the figure, the linkage 920 is coupled to the bottom panel 932. The concurrent movement in certain embodiments is facilitated by an edge of the outer ⅕ 928 or the top panel 738 being attached to an edge of the side panel 926. Similarly, the edge of the bottom panel 932 may be coupled to the edge of the side panel 902.

The passive actuator 924, which may be a spring or a gas spring, can be attached to the door or the cargo body on one end of the linkage 920 via a joint as described above. The passive actuator 924 may bias the panels into the deployed position by pushing on the linkage 920. The active actuator, which is a pneumatic actuator in this example, can be attached to the door of the cargo body on one end and the linkage 920 via a joint. The active actuator 912 overcomes the biasing force of the passive actuator 924 and pulls the linkage 920 to retract the panels. In certain embodiments, once retracted, the latch 100 engages the panels to prevent the passive actuator 924 from re-deploying the panels.

The above description provides for a passive actuator to deploy the aerodynamic structure and an active actuator to retract the aerodynamic structure. In certain embodiments, the passive actuator may retract the aerodynamic structure and the active actuator may deploy the aerodynamic structure. Also, in other embodiments one or more active actuator may both deploy and retract the structure.

FIG. 10 is a functional block diagram of a system 1000 for controlling the active actuator 912 described above. The system 1000 is powered by the vehicle power system 1002 that provides power to a speed sensor 1004, which may be a radar sensor, hub odometer 450 as described above, or another speed sensor. The speed sensor 1004 may incorporate a processor or be operatively coupled (wired or wirelessly) to a processor to determine whether the panels should be retracted or deployed. Thus, in one embodiment, the speed sensor 1004 may send a single to the processor 204 as described above, which would facilitate latching or unlatching. FIG. 21 shows the speed sensor 1004 receives signals from a wheel seed sensor 1006 and proximity sensor 1008.

The speed sensor 1004 (or an associated processor) may determine vehicle speed and proximity to other objects using various methods, as described herein. The speed sensor 1004 may include an accelerometer to determine motion and speed. In other aspects, the speed sensor 1004 may use the ABS wheel speed sensor. In other aspects, pressure sensors may be used to detect pressure in an air stream or the rear of the trailer to calculate speed using aerodynamics. Still other embodiments may include radar systems to determine speed.

Regardless of how, when speed sensor 1004 (or the associated processor such as processor 204) determine the panels should be retracted, a signal is sent to a solenoid controlled valve 1010, which signal may be from the latch driver 200 via, for example, the capacitor further discharge or the leakage current. The signal may cause the solenoid controlled valve 1010 to open or close depending on the configuration. Retracting the panels may be caused by opening the solenoid controlled valve 1010 to cause the active actuator 912 to pull the panels into the retracted position. Alternatively, retracting the panels may be caused by closing the solenoid controlled valve 1010 and venting the piston of active actuator 912 to allow the passive actuator 924 to pull the panels close. The solenoid controlled valve 1010 may maintain the state (of open or closed) regardless of power to the solenoid controlled valve. The solenoid controlled valve 1010 may be an independent battery powered pneumatic solenoid valve that has the ability to stay in its last commanded state without power (via springs/mass/friction/etc.) This allows the solenoid valve to take commands from the latch driver (or speed sensor, processor, or the like) and actuate the tail with minimal power consumption. Additionally, the processor programming logic (such as the processor 204) can be used to minimize cycling the tail. Thus, if the signal sent to the solenoid controlled valve 1010 opens the valve, the solenoid controlled valve will remain in the open state until a subsequent signal causes the solenoid controlled valve 1010 to close. Similarly, if the signal sent to the solenoid controlled valve 1010 closes the valve, the solenoid controlled valve will remain in the closed state until a subsequent signal causes the solenoid controlled valve 1010 to open. The solenoid controlled valve 1010 may have a default state in certain embodiments such that a power failure causes the solenoid controlled valve to default to either the open or closed state.

An air supply 1012 may be provided by the vehicle or from ambient air with a compressor. A regulator or pressure protection valve 1014 may regulate the pressure and prevent total loss of the air supply in the event of a failure. Optionally, the air supply 1012 may include a check valve or one-way valve 1016 to inhibit back flow of fluid. The optional check valve or one-way valve 1016 also allows the device's air system to keep pressure in the event of a system shut off or leak in the supply. The supply of air, whether vehicle or ambient, may pass through an air filter 1018 and a dryer/desiccant 1020 to remove moisture. The solenoid controlled valve 1010 may direct air via path A to the actuators. In this case, the outlet 1022 of the solenoid controlled valve 1010 passed through a split valve 1028 to direct air to both the curb side actuator 1030 and the road-side (or drive side) actuator 1032. When air is no-longer to be directed to the actuators, the solenoid controlled valve 1010 closes. Closing the solenoid controlled valve 1010 may place the actuator side of the system in fluid communication with atmosphere to vent the actuators via path B to an outlet 1024. In certain embodiments, the vent to atmosphere may include another check-valve or one way valve 1026.

The steps of a method or algorithm described in connection with the embodiments disclosed herein may be embodied directly in hardware, in a non-transient software module executed by a processor, or in a combination of the two. A non-transient software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. For the purposes of the present application, the methods and computer program products described herein do not solely comprise electrical or carrier signals, and are non-transitory.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. An apparatus comprising:
a latch movable between a hold and a release position wherein the latch is operatively configured to hold a member from an aerodynamic device in the hold position and releases the member in the release position; and
a latch driver electrically coupled to the latch, the latch driver comprising a transceiver and a processor where the processor is configured to determine whether an actual speed of a vehicle to which the latch driver is attached exceeds a threshold speed and to generate a control signal causing the latch to transition from the hold position to the release position when the actual speed is equal to or exceeds the threshold speed and to maintain the latch in the hold position when the actual speed is less than the threshold speed, the processor generating an alert signal when the latch has been moved to the release position.

2. The apparatus of claim 1 further comprising,
a speed sensor to generate a signal indicative of the actual speed of the vehicle, the speed sensor comprising a processor and a transmitter wherein the transmitter transmits the signal indicative of the actual speed to the latch driver.

3. The apparatus of claim 2 wherein the speed sensor comprises a radar speed sensor.

4. The apparatus of claim 2 wherein the speed sensor comprises a wheel speed sensor.

5. The apparatus of claim 2 wherein the speed sensor comprises a hub odometer.

6. The apparatus of claim 5 wherein the hub odometer comprises at least one dual axis accelerometer.

7. The apparatus of claim 1 further comprising,
an indicator having a first state and a second state that is operatively positioned to be viewable by an operator of the vehicle, the indicator including a receiver to receive the alert signal and transition from the first state to the second state on reception of the alert signal such that the operator is alerted to the release of the aerodynamic device.

8. The apparatus of claim 1 wherein the latch driver comprises:
a power source outputting a first voltage;
a voltage boost circuit coupled to the power source by a first switch and configured to output a second voltage greater than the first voltage;
a high voltage capacitor coupled to the voltage boost circuit; and
a second switch to selectively couple the high voltage capacitor to the latch when the high voltage capacitor is charged causing the latch to move to the release position,
wherein the voltage boost circuit is coupled to the power source when the processor determines the actual speed of the vehicle is above a threshold speed such that the high voltage capacitor is charged by the second voltage output from the voltage boost circuit.

9. The apparatus of claim 8 wherein the latch driver further comprises:
a discharge circuit;
a third switch; and
a power regulator,
wherein the third switch selectively couples the output of the high voltage capacitor to the power regulator after the latch is moved to the release position.

10. The apparatus of claim 9 wherein the power regulator is electrically coupled to at least the processor to provide power to the processor from either the power source or the output of the discharge circuit.

11. The apparatus of claim 5 wherein the hub odometer is an electric hub odometer.

12. The apparatus of claim 5 wherein the hub odometer is a mechanical hub odometer.

13. The apparatus of claim 1, wherein the latch driver is electrically coupled to an active actuator to cause the active actuator to at least one of actuate or de-actuate.
